(19) United States
(12) Patent Application Publication
(10) Pub. No.: US 2026/0099770 A1
(43) Pub. Date: Apr. 9, 2026

(54) METHOD AND APPARATUS FOR LIGHTWEIGHTING AI MODEL USING KNOWLEDGE DISTILLATION AND PRUNING

(71) Applicant: INDUSTRY ACADEMY COOPERATION FOUNDATION OF SEJONG UNIVERSITY, Seoul (KR)

(72) Inventors: Jae Ho KIM, Seongnam-si (KR); Dong Hoon LEE, Seoul (KR); Se Jung KIM, Seoul (KR); Yong Hyun KWON, Seoul (KR)

(21) Appl. No.: 19/299,975

(22) Filed: Aug. 14, 2025

(30) Foreign Application Priority Data
Oct. 8, 2024 (KR) 10-2024-0136634

(51) Int. Cl. G06N 20/00

(52) U.S. Cl. CPC G06N 20/00

(57) ABSTRACT

A method of lightweighting an AI model using knowledge distillation and pruning includes calculating a first loss value using an output value of a teacher model, an output value of a student model, a feature vector generated from the teacher model, a feature vector generated from the student model, and a ground truth, performing training on the student model so that the first loss value is minimized, and performing pruning on the student model using a second loss value calculated based on the feature vector generated from the teacher model and the feature vector generated from the student model.

### CROSS-REFERENCE TO RELATED APPLICATION

This application claims priority under 35 U.S.C 119(a) to Korean Patent Application No. 2024-0136634, filed on Oct. 8, 2024, the disclosure of which is incorporated herein by reference in its entirety.

### BACKGROUND

### 1. Field of the Invention

The present disclosure relates to a method and apparatus for lightweighting an artificial intelligence (AI) model, and more particularly, to a method and apparatus for lightweighting an AI model using knowledge distillation and pruning.

### 2. Discussion of Related Art

Edg-, also referred to as on-device AI, which pertains to fields that install AI functions on resource-constrained devices such as smartphones, drones, and CCTVs, is increasingly developing in order to meet requirements for real-time performance and low cost. As the model size and computational amount of deep learning models increase, their performance also improves, but the costs required for the training and inference process is also increasing rapidly. Accordingly, in order to load AI models on local devices, it is important to perform lightweighting of the models to reduce the number of parameters, computing resources, memory, computational amount, and inference speed while maintaining the accuracy of the AI model.

Representative techniques used in lightweighting such AI models are knowledge distillation and pruning. Knowledge distillation is a method of transferring the knowledge of a teacher model to a student model that is lighter than the teacher model, and pruning is a method of lightweighting a model by removing unnecessary weights.

### SUMMARY OF THE INVENTION

The present disclosure is directed to providing a method and apparatus for lightweighting an artificial intelligence (AI) model while providing high performance of the AI model using knowledge distillation and pruning.

According to an aspect of the present disclosure, there is provided a method of lightweighting an AI model using knowledge distillation and pruning, which includes: calculating a first loss value using an output value of a teacher model, an output value of a student model, a feature vector generated from the teacher model, a feature vector generated from the student model, and a ground truth; performing training on the student model so that the first loss value is minimized; and performing pruning on the student model using a second loss value calculated based on the feature vector generated from the teacher model and the feature vector generated from the student model.

According to another aspect of the present disclosure, there is provided a method of lightweighting an AI model using knowledge distillation and pruning, which includes: calculating a loss value using a feature vector generated from a teacher model and a feature vector generated from a student model; performing training with a threshold value for pruning so that the loss value is minimized; and performing pruning on weights that are lower than or equal to the threshold value among weights of the student model.

According to still another aspect of the present disclosure, there is provided an apparatus for lightweighting an AI model using knowledge distillation and pruning, which includes: a memory; and a processor electrically connected to the memory, wherein the processor calculates a first loss value using an output value of a teacher model, an output value of a student model, a feature vector generated from the teacher model, a feature vector generated from the student model, and a ground truth, performs training on the student model so that the first loss value is minimized, and performs pruning on the student model using a second loss value calculated based on the feature vector generated from the teacher model and the feature vector generated from the student model.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a diagram illustrating a method of lightweighting an artificial intelligence (AI) model using knowledge distillation and pruning according to an embodiment of the present disclosure;

FIG. 2 is a diagram illustrating a teacher model and a student model according to an embodiment of the present disclosure; and

FIG. 3 is a diagram illustrating a method of lightweighting using pruning according to an embodiment of the present disclosure.

### DETAILED DESCRIPTION OF EXEMPLARY EMBODIMENTS

The present disclosure may be subject to various changes and may have multiple embodiments, and specific embodiments are illustrated in the accompanying drawings and described in detail. However, this is not intended to limit the present disclosure to the specific embodiments and should be understood to include all changes, equivalents, or substitutes included in the spirit and technical scope of the present disclosure. Like reference numbers have been used for like elements throughout the description of each of the drawings.

Hereinafter, embodiments according to the present disclosure will be described in detail with reference to the attached drawings.

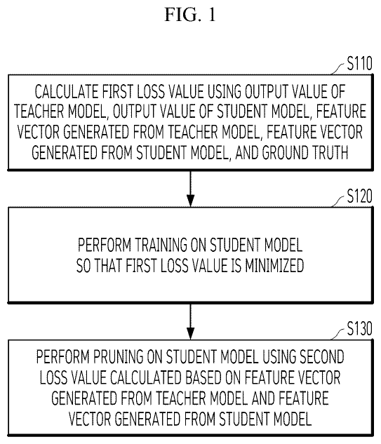

FIG. 1 is a diagram illustrating a method of lightweighting an artificial intelligence (AI) model using knowledge distillation and pruning according to an embodiment of the present disclosure.

The method of lightweighting according to the embodiment of the present disclosure may be performed in a computing device including a memory and a processor electrically connected to the memory, and the computing device may include an apparatus for lightweighting an AI model. The processor performs a series of processes for lightweighting the AI model.

The method of lightweighting according to an embodiment of the present disclosure may utilize knowledge distillation and pruning and additionally use self-distillation derived from knowledge distillation. In addition, according to an embodiment, knowledge distillation and pruning may be performed simultaneously or selectively utilized.

Referring to FIG. 1, in operation S110, the computing device according to the embodiment of the present disclosure calculates a first loss value using an output value of a teacher model, an output value of a student model, a feature vector generated from the teacher model, a feature vector generated from the student model, and a ground truth. Next, in operation S120, the computing device performs training on the student model so that the first loss value is minimized.

In operations S110 and S120, the computing device may generate a lightweight student model by performing training on the student model using both knowledge distillation and self-distillation. As an example, the teacher model and the student model may be deep learning models that classify input tensors.

Subsequently, in operation S130, the computing device performs pruning on the student model using a second loss value calculated based on the feature vector generated from the teacher model and the feature vector generated from the student model. That is, in operation S130, the computing device additionally performs pruning on the student model, thereby further lightweighting the student model.

According to an embodiment of the present disclosure, by applying both knowledge distillation and pruning, a more lightweight AI model can be provided while providing high performance.

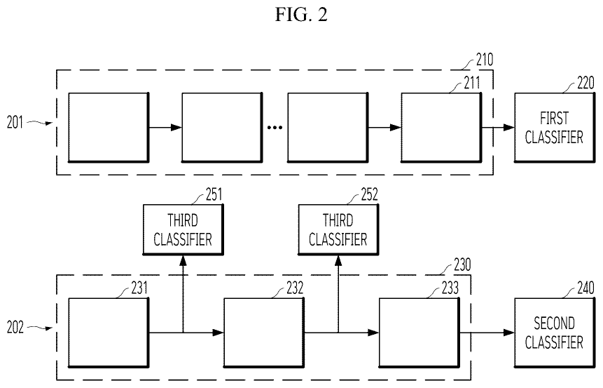

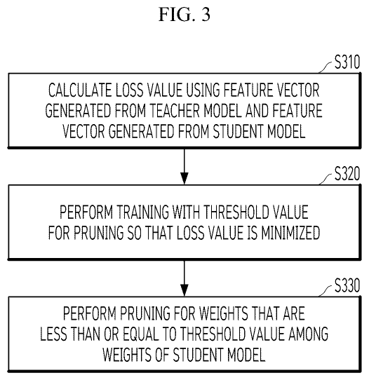

The method of lightweighting the AI model using knowledge distillation and pruning is described in more detail in FIGS. 2 and 3.

### Lightweighting Using Knowledge Distillation

FIG. 2 is a diagram illustrating a teacher model and a student model according to an embodiment of the present disclosure.

Referring to FIG. 2, the teacher model and the student model according to an embodiment of the present disclosure may include a plurality of blocks and a classifier. Here, the block corresponds to a layer or a set of multiple layers and may be a convolutional network such as ResNet that extracts features from an input tensor. The number of blocks may vary depending on the embodiment, and the number of blocks included in the student model may be designed to be less than the number of blocks included in the teacher model. The classifier may include an artificial neural network.

A teacher model 201 includes a plurality of first blocks 210 and a first classifier 220. The first blocks 210 generate a feature vector for an input tensor, and the first classifier 220 classifies the class of the input tensor based on a first feature vector output from the last block 211 among the first blocks. The first classifier 220 outputs a probability value for the class of the input tensor.

A student model 202 includes a plurality of second blocks 230, a second classifier 240, and a plurality of third classifiers 251 and 252. The second blocks 230, like the first blocks 210, generate the feature vector for the input tensor, and the second classifier 240, like the first classifier 220, classifies the class of the input tensor based on a second feature vector output from the last block 233 among the second blocks. The second classifier 240 outputs a probability value for the class of the input tensor.

The third classifiers 251 and 252 classify the class of the input tensor based on a third feature vector output from each of the second blocks 231 and 232. That is, the third classifiers 251 and 252 receive a third feature vector from a branch between the second blocks 230, classify the class of the input tensor, and output a probability value for the class of the input tensor. According to an embodiment, the third feature vector output from the branch between the second blocks 230 may be input to the third classifiers 251 and 252 through a bottleneck block that adjusts the dimension of the third feature vector.

As an example, the computing device may calculate a first loss value L_{Total} as provided in Expression 1 using a predetermined loss function and perform training on the student model so that the first loss value is minimized. That is, the computing device can calculate the first loss value by adding up all of L_{Ground truth}, L_{KL Divergence}, and L_{Features}, which are respectively calculated.

$${L}_{Total} = {L}_{Ground truth} + {L}_{KL Divergence} + {L}_{Features} \qquad [ Expression 1 ]$$

The computing device calculates a loss value L_{Ground truth} by adding a loss value calculated using an output value of the second classifier 240 and a ground truth for the input tensor and a loss value calculated using an output value of each of the third classifiers 251 and 252 and the ground truth for the input tensor. The loss value for the output value of each of the third classifiers 251 and 252 and the ground truth for the input tensor are calculated based on each of the third classifiers 251 and 252, and the values calculated for each of the third classifiers 251 and 252 are added to derive L_{Ground truth}. L_{Ground truth} may be calculated through a cross entropy loss function.

Next, the computing device calculates a loss value L_{KL Divergence} by adding a loss value calculated using an output value of the first classifier 220 and the output value of each of the third classifiers 251 and 252, and a loss value calculated using the output value of the first classifier 220 and the output value of the second classifier 240. When L_{KL Divergence} is calculated, the output value of the first classifier 220 may be used as the ground truth, and the output values of the first classifier 220, the second classifier 240, and the third classifiers 251 and 252 may be adjusted from a hard label to a soft label through a temperature value, which is one of the knowledge distillation parameters, and then the corresponding loss value can be calculated. L_{KL Divergence} may be calculated through a Kullback-Leibler (KL) divergence loss function.

Next, the computing device may calculate a loss value L_{Features} using a first feature vector output from the last block 211 among the first blocks and a third feature vector output from each of the second blocks 231, 232, and 233, and as an example, the loss value L_{Features} may be calculated as provided in Expression 2.

$$‖ {F}_{i} - {F}_{C} ‖ \qquad [ Expression 2 ]$$

Here, Fᵢ denotes a third feature vector, F_{c} denotes a first feature vector, and the loss value L_{Features} may correspond to a sum of distance values between the first feature vector and the third feature vector calculated for each of the third feature vectors and correspond to an L2-Norm operation value.

Meanwhile, since each of the third feature vectors and the first feature vector are generated through different blocks, their dimensions may be different from each other, and this difference in dimension may be resolved through the above-described bottleneck block.

According to an embodiment of the present disclosure, the performance of the student model may be improved by performing training on the student model through knowledge distillation and self-distillation.

### Lightweighting Using Pruning

FIG. 3 is a diagram illustrating a method of lightweighting using pruning according to an embodiment of the present disclosure.

Referring to FIGS. 2 and 3, in operation 310, the computing device according to an embodiment of the present disclosure calculates a loss value using a feature vector generated from a teacher model 201 and a feature vector generated from a student model 202 and performs training with a threshold value for pruning so that the loss value is minimized in operation S320. Here, the loss value may correspond to a loss value calculated using a first feature vector output from the last block 211 among the first blocks of the teacher model 201 and a third feature vector output from each of the second blocks 231, 232, and 233 of the student model 202.

At this time, the threshold value for pruning may be assigned to each of the second blocks 231, 232, and 233 of the student model 202, and therefore, training with the threshold value may be performed for each of the second blocks 231, 232, and 233 of the student model 202.

Next, in operation S330, the computing device performs pruning for weights that are less than or equal to the threshold value among the weights of the student model. The computing device compares the threshold value trained for each of the second blocks 231, 232, and 233 with the weights of the second blocks and removes edges assigned with the weights less than or equal to the threshold value in the second blocks 231, 232, and 233.

In addition, the computing device may update the weights greater than the threshold value among the weights of the student model using Expression 3. In other words, the computing device does not remove the weights greater than the threshold value, but also updates the weights greater than the threshold value with new weights.

$$σ ( \frac{\vert {w}_{ij} - {θ}_{M a s k} \vert}{τ} ) \qquad [ Expression 3 ]$$

Here, σ denotes a sigmoid function, wᵢⱼ denotes a weight greater than a threshold value, θ_{Mask} denotes a threshold value assigned to each of the second blocks 231, 232, and 233, and τ denotes a temperature value used for knowledge distillation.

According to an embodiment of the present disclosure, by performing training with the threshold value for pruning, pruning is performed, thereby lightweighting an AI model without deteriorating the performance of the AI model.

As described above, by applying both knowledge distillation and pruning, a more lightweight AI model can be provided while providing high performance.

In addition, according to an embodiment of the present disclosure, by performing training on a student model through knowledge distillation and self-distillation, the performance of the student model can be improved.

In addition, according to an embodiment of the present disclosure, by performing pruning through training with a threshold value for pruning, lightweighting of an AI model can be performed without deteriorating the performance of the AI model.

The technical content described above may be implemented in the form of program instructions executable by various computer means and may be recorded on computer readable media. The computer readable media may be provided with program instructions, data files, data structures, and the like alone or in combination. The program instructions stored in the computer readable media may be specially designed and constructed for the purposes of the present disclosure or may be well known and available to those skilled in the art of computer software. The computer readable storage media include hardware devices configured to store and execute program instructions. For example, the computer readable storage media include magnetic media such as hard disks, floppy disks, and magnetic tape, optical media such as a CD-ROM and a digital video disk (DVD), magneto-optical media such as floptical disks, a ROM, a RAM, a flash memory, etc. The program instructions include not only machine language code made by a compiler but also high level code that can be used by an interpreter etc., which is executed by a computer. A hardware device may be configured to operate as one or more software modules to perform the operations of the embodiments, and vice versa.

While the present disclosure has been shown and described with respect to particulars, such as specific components, embodiments, and drawings, the embodiments are used to aid in the understanding of the present disclosure rather than limiting the present disclosure, and those skilled in the art should appreciate that various changes and modifications are possible without departing from the spirit and scope of the disclosure. Therefore, the spirit of the present disclosure is not defined by the embodiments, and the scope of the present disclosure is to cover not only the following claims but also all modifications and equivalents derived from the claims.

What is claimed is:

1. A method of lightweighting an artificial intelligence (AI) model using knowledge distillation and pruning, the method comprising:
calculating a first loss value using an output value of a teacher model, an output value of a student model, a feature vector generated from the teacher model, a feature vector generated from the student model, and a ground truth;
performing training on the student model so that the first loss value is minimized; and
performing pruning on the student model using a second loss value calculated based on the feature vector generated from the teacher model and the feature vector generated from the student model.

2. The method of claim 1, wherein:
the teacher model includes a plurality of first blocks for generating a feature vector for an input tensor, and a first classifier for classifying the input tensor based on a first feature vector output from a last block of the first blocks; and
the student model includes a plurality of second blocks for generating the feature vector for the input tensor, a second classifier for classifying the input tensor based on a second feature vector output from a last block of the second blocks, and a plurality of third classifiers for classifying the input tensor based on a third feature vector output from each of the second blocks.

3. The method of claim 2, wherein the calculating of the first loss value includes calculating the first loss value by adding a loss value calculated using an output value of the second classifier and the ground truth, a loss value calculated using an output value of each of the third classifiers and the ground truth, a loss value calculated using an output value of the first classifier and the output value of each of the third classifiers, a loss value calculated using the output value of the first classifier and the output value of the second classifier, and a loss value calculated using the first feature vector and the third feature vector.

4. The method of claim 3, wherein the loss value calculated using the first feature vector and the third feature vector corresponds to a sum of distance values between the first feature vector and each of the third feature vectors.

5. The method of claim 3, wherein the performing of pruning on the student model includes
performing training with a threshold value for pruning for each of the second blocks so that the second loss value corresponding to the loss value calculated using the first feature vector and the third feature vector is minimized, and
performing pruning on weights that are less than or equal to the threshold value among weights of the student model.

6. The method of claim 5, wherein the performing of pruning on the student model includes further updating weights that are greater than the threshold value among the weights of the student model using a following Expression:
$$σ ( \frac{\vert {w}_{ij} - {θ}_{M a s k} \vert}{τ} ) , \qquad [ Expression ]$$
where σ denotes a sigmoid function, wᵢⱼ denotes a weight greater than the threshold value, θ_{Mask} denotes the threshold value assigned to each of the second blocks, and τ denotes a temperature value used for knowledge distillation.

7. A method of lightweighting an artificial intelligence (AI) model using knowledge distillation and pruning, the method comprising:
calculating a loss value using a feature vector generated from a teacher model and a feature vector generated from a student model;
performing training with a threshold value for pruning so that the loss value is minimized; and
performing pruning on weights that are less than or equal to the threshold value among weights of the student model.

8. The method of claim 7, wherein:
the teacher model includes a plurality of first blocks for generating a feature vector for an input tensor, and the student model includes a plurality of second blocks for generating the feature vector for the input tensor;
the calculating of the loss value includes calculating the loss value using a first feature vector output from a last block of the first blocks and a second feature vector output from each of the second blocks; and
the threshold value is a threshold value assigned to each of the second blocks.

9. The method of claim 8, wherein the loss value corresponds to a sum of distance values between the first feature vector and each of the second feature vectors.

10. An apparatus for lightweighting an artificial intelligence (AI model) using knowledge distillation and pruning, the apparatus comprising:
a memory; and
a processor electrically connected to the memory,
wherein the processor is configured to:
calculate a first loss value using an output value of a teacher model, an output value of a student model, a feature vector generated from the teacher model, a feature vector generated from the student model, and a ground truth;
perform training on the student model so that the first loss value is minimized; and
perform pruning on the student model using a second loss value calculated based on the feature vector generated from the teacher model and the feature vector generated from the student model.
